(19) United States
(12) Patent Application Publication
(10) Pub. No.: US 2013/0274421 A1
(43) Pub. Date: Oct. 17, 2013

(54) HIGHLY PURE POLOXAMERS AND PURIFICATION METHOD THEREOF

(71) Applicants: Bong Oh Kim, Daejeon (KR); Min Hyo Seo, Daejeon (KR)

(72) Inventors: Bong Oh Kim, Daejeon (KR); Min Hyo Seo, Daejeon (KR)

(73) Assignee: SAMYANG BIOPHARMACEUTICALS CORPORATION, Seoul (KR)

(21) Appl. No.: 13/976,228

(22) PCT Filed: Dec. 22, 2011
(86) PCT No.: PCT/KR11/09974

§ 371 Date: Jun. 26, 2013

(30) Foreign Application Priority Data
Dec. 28, 2010 (KR) 10-2010-0136671

(51) Int. Cl. C08G 65/30

(52) U.S. Cl. CPC C08G 65/30
USPC 525/409

(57) ABSTRACT

Disclosed are a method for purifying poloxamers, comprising dissolving poloxamers in an organic solvent to prepare a polymer solution, and removing organometals or water from the polymer solution by at least one physical method selected from mixing of activated carbon with the polymer solution and centrifugation of the polymer solution, and poloxamers purified by the method.

### TECHNICAL FIELD

The present disclosure relates to a method for purifying poloxamers used as a drug delivery system using sol-gel transition.

### BACKGROUND ART

Poloxamers, which are used as a drug delivery system and an adhesion barrier, is a polymer produced by BASF. The poloxamers are known as thermosensitive materials existing in solution state at low temperatures but gelling at elevated temperatures (see U.S. Pat. Nos. 4,188,373, 4,478,822 and 4,474,751). Bromberg s U.S. Pat. No. 5,939,485 describes the property of reversible gelation of the poloxamer in response to a change in an environmental stimulus such as pH, temperature or ionic strength.

The generally known poloxamer has a structure of polyethylene oxide (PEO)-polypropylene oxide (PPO)-polyethylene oxide (PEO). For example, the gelation temperature of Poloxamer 407 is about 25 C and the gelation is affected by poloxamer grade, concentration, pH, additives, or the like.

U.S. Pat. Nos. 5,800711, 3,492,358 and 3,478,109 disclose solvent extraction and phase separation methods for purifying low-molecular-weight poloxamers. However, these processes require long processing time, consume large amount of organic solvents, provide low yield and have the difficulty of removing water from the purified polymer.

In the solvent-nonsolvent method commonly employed for polymer purification, selection of the nonsolvent that dissolves impurities but not the polymer is important. Since organometals are not dissolved in organic solvents, the solvent-nonsolvent method is inappropriate for removal of organometals.

Also, water-organic solvent phase separation is employed to remove impurities included in the polymer. However, since the poloxamer is an amphiphilic surfactant, water and the organic solvent tend to be mixed as emulsion rather than being separated. Accordingly, it is difficult to use the water-organic solvent phase separation method. Thus, in U.S. Pat. No. 5,800,711, a salt such as sodium chloride is added and the water-organic solvent mixture is stored at a predetermined temperature for a long time to allow phase separation. Since this method is not so effective in removing impurities, the procedure should be repeated several times to obtain purified poloxamer. However, the repeated process results in decreased yield.

Although the poloxamer forms a polymer gel in an aqueous solution, it is easily disintegrated due to weak gel strength and cannot stay long enough for drug delivery or prevention of adhesion. To solve this problem, the gel strength should be increased at the same concentration. The gel strength increases as the molecular weight of the polymer is larger. In order to increase the molecular weight while retaining the composition of the poloxamer and the sol-gel transition phenomenon, a chain extender is used to synthesize a multiblock copolymer having the unit block PEO-PPO-PEO of the poloxamer. However, when impurities are present in the poloxamer, chain extension is not achieved and discoloration often occurs due to side reaction. Accordingly, it is necessary to purify the poloxamer to reduce impurities.

When the poloxamer is purified using water or alcohol, reaction of the chain extender with the hydroxyl groups of the poloxamer may be interrupted unless the water or alcohol is completely removed. Accordingly, a method for purifying the poloxamer without using water or alcohol is required.

### DISCLOSURE OF INVENTION

### Technical Problem

The present disclosure is directed to providing a method for purifying poloxamers using activated carbon or by centrifugation and a purified poloxamer with impurities or water removed.

### Solution to Problem

In one general aspect, the present disclosure provides a method for purifying poloxamers, comprising: (a) dissolving poloxamers in an organic solvent to prepare a polymer solution; and (b) removing organometals or water from the polymer solution by a physical method.

In another general aspect, the present disclosure provides poloxamers purified by the purification method.

### Advantageous Effects of Invention

The poloxamers purified by the method according to the present disclosure can be reacted with a chain extender to increase the molecular weight. Also, the multiblock copolymers prepared using the purified poloxamers include less organometals and have reduced residues on ignition. Furthermore, discoloration of the polymer can be prevented since side reaction with the organometal impurities is minimized.

### BEST MODE FOR CARRYING OUT THE INVENTION

Hereinafter, the embodiments of the present disclosure will be described in detail.

The inventors of the present disclosure have found out that, when the commercially available Poloxamer 407 (BASF) is reacted with a dicarboxylic chloride derivative, which is a chain extender, the increase in molecular weight is only slight due to the impurities present in the poloxamer. It is because the impurities interrupt the reaction of the terminal groups of the poloxamer with the chain extender. Such impurities include the organometal compounds used in the polymerization of the poloxamer. Thus, the inventors of the present disclosure have developed a method for purifying poloxamers capable of remarkably reducing the quantity of the organometals.

The present disclosure provides a method for purifying poloxamers, comprising: (a) dissolving poloxamers in an organic solvent to prepare a polymer solution; and (b) removing organometals or water from the polymer solution by a physical method.

The physical method in the step (b) may be at least one selected from mixing of activated carbon with the polymer solution and centrifugation of the polymer solution. Activated carbon may be mixed with the polymer solution to adsorb the organometals or water. Also, the polymer solution may be centrifuged to remove the organometals or water. Furthermore, the polymer solution may be centrifuged before or after mixing activated carbon with the polymer solution in order to remove the organometals or water.

When the polymer solution is centrifuged, the organometals not dissolved in acetonitrile are precipitated and removed. Since the organometals not dissolved in acetonitrile are very finely dispersed, a very high rotation speed is required during the centrifugation. But, the rotation speed of the centrifuge can be lowered when the concentration of the poloxamer dissolved in acetonitrile is low. In an exemplary embodiment of the present disclosure, the rotation speed during the centrifugation may be 3,000-15,000 rpm, specifically 8,000-10,000 rpm.

In an exemplary embodiment of the present disclosure, the organic solvent in the step (a) may be selected from a group consisting of acetonitrile, acetone, chloroform, methylene chloride, tetrahydrofuran and alcohol, but is not limited thereto. The alcohol may be C₁-C₄ alcohol. Specifically, ethanol may be used. When the poloxamers are dissolved in the organic solvent, the solution becomes hazy due to the organometals.

In an exemplary embodiment of the present disclosure, in the step (a), the organic solvent may be used in an amount of 100-500 v/w %, specifically 100-250 v/w %, based on the poloxamers. When the organic solvent is used in an amount less than 100 v/w %, the polymer solution is not mixed well with activated carbon because of increased viscosity, resulting in decreased adsorption. And, when the organic solvent is used in an amount more than 500 v/w %, the process of removing the organic solvent becomes complicated and expensive.

In an exemplary embodiment of the present disclosure, in the step (b), the activated carbon may be used in an amount of 5-50 wt %, specifically 10-30 wt %, based on the poloxamers. When the activated carbon is used in an amount less than 5 wt %, the organometals may not be completely removed. And, when the activated carbon is used in an amount more than 50 wt %, a long time is required for filtration without further improvement of the organometal removal efficiency, thus resulting in reduced purification yield.

In an exemplary embodiment of the present disclosure, in the step (b), the activated carbon and the polymer solution may be mixed for 6-48 hours, specifically for 12-24 hours, at room temperature. When the mixing time is shorter than 6 hours, all the organometals may not be adsorbed to the activated carbon. And, a mixing time exceeding 48 hours is unnecessary since all the organometals have been already adsorbed to the activated carbon. When the mixture solution is allowed to stand alone after the mixing, the activated carbon is precipitated and a solution of pure poloxamers can be obtained.

In an exemplary embodiment of the present disclosure, a step of (c) removing the activated carbon and distilling the organic solvent may be further included after the step (b), when the purification method comprises the mixing of activated carbon with the polymer solution.

In an exemplary embodiment of the present disclosure, a step of (c′) removing the activated carbon and precipitating polymer solution with a nonsolvent which does not dissolve the polymer may be further included after the step (b), when the purification method comprises the mixing of activated carbon with the polymer solution.

The activated carbon may be removed by filtration.

In an exemplary embodiment of the present disclosure, the nonsolvent may be hexane or ether.

In an exemplary embodiment of the present disclosure, a step of recovering the polymer solution by centrifuging the polymer solution may be further included before the step (b), when the purification method comprises the mixing of activated carbon with the polymer solution.

In an exemplary embodiment of the present disclosure, a step of recovering the polymer solution by centrifuging the polymer solution may be further included after the step (b) and before the step (c) or (c′), when the purification method comprises the mixing of activated carbon with the polymer solution.

The present disclosure also provides poloxamers purified by the purification method. The poloxamers may have an organometal content of 10-100 ppm and a water content of 10-500 ppm.

The examples and experiments will now be described.

The following examples are for illustrative purposes only and not intended to limit the scope of the present disclosure.

### EXAMPLE 1

### Purification of Poloxamers (Activated Carbon Adsorption)

Poloxamer 407 (500 g) was dissolved in acetonitrile (1,000 mL) in a 2-L beaker while stirring with an impeller. After adding activated carbon (50 g), the resulting polymer solution was further stirred for 24 hours using the impeller. After stopping the impeller and waiting for 6 hours, the polymer solution of the upper layer was filtered first through 7-μm filter paper and then through 1-μm filter paper to remove the activated carbon. Thus obtained poloxamer solution was dropped onto hexane (5 L) to precipitate the poloxamer, which was filtered and dried at room temperature in vacuum for 24 hours. The yield was 364 g.

Organometal (K) content of the poloxamer obtained as white solid was measured using inductively coupled plasma (ICP). Also, residues on ignition and water content were measured. The result is shown in Table 1.

### EXAMPLE 2

### Purification of Poloxamers (Activated Carbon Adsorption)

Poloxamer 407 was purified in the same manner as in Example 1, except that 75 g of activated carbon was used. The polymer yield was 354 g. ICP (K content), residues on ignition and water content of the purified poloxamer are shown in Table 1.

### EXAMPLE 3

### Purification of Poloxamers (Activated Carbon Adsorption)

Poloxamer 407 was purified in the same manner as in Example 1, except that 100 g of activated carbon was used. The polymer yield was 360 g. ICP (K content), residues on ignition and water content of the purified poloxamer are shown in Table 1.

### EXAMPLE 4

### Purification of Poloxamers (Centrifugation and Activated Carbon Adsorption)

Poloxamer 407 (500 g) was dissolved in acetonitrile (1,000 mL) in a 2-L beaker while stirring with an impeller. The resulting polymer solution was transferred to Nalgene centrifugation bottles, 250 mL per each, and centrifuged at 8,500 rpm for 1 hour (Supora 22K, Hanil Science). The polymer solution of the upper layer was recovered and the precipitated organometals were removed. After adding activated carbon (75 g) to the obtained poloxamer solution, the resulting polymer solution was stirred for 24 hours using the impeller. After stopping the impeller and waiting for 6 hours, the polymer solution of the upper layer was filtered first through 7-μm filter paper and then through 1-μm filter paper to remove the activated carbon. Thus obtained poloxamer solution was dropped onto hexane (5 L) to precipitate the poloxamer, which was filtered and dried at room temperature in vacuum for 24 hours. The yield was 331 g. ICP (K content), residues on ignition and water content of the purified poloxamer are shown in Table 1.

### EXAMPLE 5

### Purification of Poloxamers (Centrifugation)

Poloxamer 407 (500 g) was completely dissolved in acetonitrile (1,000 mL) in a 2-L beaker while stirring with an impeller. The resulting polymer solution was transferred to Nalgene centrifugation bottles, 250 mL per each, and centrifuged at 8,500 rpm for 1 hour (Supora 22K, Hanil Science). The polymer solution of the upper layer was recovered and the precipitated organometals were removed. The recovered poloxamer solution was dropped onto hexane (5 L) to precipitate the poloxamer, which was filtered and dried at room temperature in vacuum for 24 hours. The yield was 395 g. ICP (K content), residues on ignition and water content of the purified poloxamer obtained as white solid are shown in Table 1.

### Comparative Example 1

### Purification of Poloxamers (Solvent-Nonsolvent Precipitation)

Poloxamer 407 (500 g) was dissolved in acetonitrile (1,000 mL) in a 2-L beaker while stirring with an impeller. The resulting polymer solution was dropped onto hexane (5 L) to precipitate the poloxamer, which was filtered and dried at room temperature in vacuum for 24 hours. The yield was 433 g. ICP (K content), residues on ignition and water content of the purified poloxamer obtained as white solid are shown in Table 1.

### Comparative Example 2

### Purification of Poloxamers (Phase Separation)

Poloxamer 407 was purified according to the method disclosed in U.S. Pat. No. 5,800,711. Poloxamer 407 (25 g) was dissolved in a mixture solution (800 mL) of n-propanol/distilled water (75/25, v/v) in a 1-L beaker. After adding sodium chloride (65 g) and dissolving, the resulting solution was transferred to a separatory funnel and kept at 30° C. After about 15 hours, the solution was separated into two layers. The lower layer was removed and a mixture solution of n-propanol/distilled water (75/25, v/v) was supplemented with the same volume as that of the discarded lower layer solution. After adding sodium chloride with the original concentration of ˜80 mg/mL and dissolving, the resulting solution was kept at 30° C. for phase separation. The addition amount of sodium chloride was determined considering the change of the sodium chloride concentration caused by the removal and supplementation of the n-propanol/distilled water solvent. This procedure was repeated 7 more times. The poloxamer solution of the upper layer in the separatory funnel was subjected to fractional distillation to remove the solvent and then added to hexane (1 L) to pre-cipitate the poloxamer, which was filtered and dried at room temperature in vacuum for 24 hours. The yield was 17 g. ICP (K content), residues on ignition and water content of the purified poloxamer are shown in Table 1. Although the poloxamer contains various metals in addition to K, only the K content was measured because other metals are present in trace amounts.

Table 1

TABLE 1

| | Activated | K | | Water |
|---|---|---|---|---|
| | carbon (based | content | Residues on | content |
| | on poloxamer) | (ppm) | ignition (%) | (ppm) |
| Poloxamer 407 | — | 717.0 | 0.17 | 345 |
| Comparative | — | 650.4 | 0.25 | 287 |
| Example 1 | | | | |
| Comparative | — | 83.5 | 0.05 | 1,157 |
| Example 2 | | | | |
| Example 1 | 10 wt % | 74.9 | N.D. | 236 |
| Example 2 | 15 wt % | 59.0 | N.D. | 347 |
| Example 3 | 20 wt % | 40.4 | N.D. | 219 |
| Example 4 | 15 wt % | 35.8 | N.D. | 282 |
| Example 5 | — | 92.3 | 0.03 | 256 |

Comparative Example 1, solvent-nonsolvent precipitation showed little purification effect. Comparative Example 2 showed a little purification effect, but water content increased greatly. Therefore, a process of removing water is required for reaction with a chain extender.
In contrast, the purification methods according to present disclosure exhibited about low organometal (K) content of 5-20%, few residues on ignition of 20% or less and very low water content, when compared with unpurified Poloxamer 407.

### EXAMPLE 6

### Synthesis of Multiblock Poloxamer

The poloxamer purified in Example 2 (10 g) was added to a 100 mL flask together with a magnetic bar. Then, water included in the polymer was removed for 2 hours by heating and decompression (1 ton or lower) in an oil bath of 120° C. After releasing the decompression, dehydrated acetonitrile (50 mL) was added at 120° C. while flowing nitrogen in order to completely dissolve the poloxamer. Then, succinyl chloride (192 μl, 2 equivalents of poloxamer) diluted in dehydrated acetonitrile (10 mL) was slowly added for 20 hours using a syringe pump. After the addition of succinyl chloride was completed, reaction was further carried out for 4 hours at the same temperature. The total reaction time was 24 hours. Thus synthesized multiblock poloxamer was pre-cipitated in diethyl ether (1 L), filtered and dried in vacuum to obtain the product as white solid (8.4 g). Molecular weight of the resulting multiblock poloxamer was measured by GPC, and intrinsic viscosity (25° C., in chloroform solvent) was also measured. The result is shown in Table 2.

### Comparative Example 3

### Synthesis of Multiblock Poloxamer

A multiblock poloxamer (7.9 g) was synthesized in the same manner as in Example 6, except that the poloxamer purified in Comparative Example 1 (10 g) was used. Molecular weight of the resulting multiblock poloxamer was measured by GPC, and intrinsic viscosity (25° C., in chloroform solvent) was also measured. The result is shown in Table 2.

TABLE 2

| | Weight-average | Intrinsic |
|---|---|---|
| | molecular weight (M_{w}) | viscosity |
| Poloxamer 407 | 24,000 | 0.35 |
| Comparative Example 3 | 58,100 | 1.07 |
| Example 6 | 125,000 | 1.74 |

The multiblock poloxamer synthesized in Example 6 showed a remarkably increased molecular weight, whereas that of Comparative Example 3 showed a molecular weight increased only by 2-3 times.

Those skilled in the art will appreciate that the conceptions and specific embodiments disclosed in the foregoing description may be readily utilized as a basis for modifying or designing other embodiments for carrying out the same purposes of the present disclosure. Those skilled in the art will also appreciate that such equivalent embodiments do not depart from the spirit and scope of the disclosure as set forth in the appended claims.

1. A method for purifying poloxamers, comprising:
dissolving poloxamers in an organic solvent to prepare a polymer solution; and
removing organometals or water from the polymer solution by a physical method.

2. The method for purifying poloxamers according to claim 1, wherein the physical method comprises at least one selected from mixing of activated carbon with the polymer solution and centrifugation of the polymer solution.

3. The method for purifying poloxamers according to claim 2, wherein the physical method comprises mixing of activated carbon with the polymer solution.

4. method for purifying poloxamers according to claim 3, which further comprises, after said removing organometals or water from the polymer solution, removing the activated carbon and distilling the organic solvent, or removing the activated carbon and precipitating polymer solution with a nonsolvent which does not dissolve the polymer.

5. The method for purifying poloxamers according to claim 4, wherein the nonsolvent is hexane or ether.

6. The method for purifying poloxamers according to claim 1, wherein the organic solvent is selected from a group consisting of acetonitrile, acetone, chloroform, methylene chloride, tetrahydrofuran and alcohol.

7. The method for purifying poloxamers according to claim 1, wherein the organic solvent is used in an amount of 100-500 v/w % based on the poloxamers.

8. The method for purifying poloxamers according to claim 2, wherein the physical method comprises mixing of activated carbon with the polymer solution and the activated carbon is used in an amount of 5-50 wt % based on the poloxamers.

9. The method for purifying poloxamers according to claim 2, wherein the physical method comprises mixing of activated carbon with the polymer solution and the activated carbon and the polymer solution are mixed for 6-48 hours.

10. The method for purifying poloxamers according to claim 3, which further comprises, before said removing organometals or water from the polymer solution, recovering the polymer solution by centrifuging the polymer solution.

11. The method for purifying poloxamers according to claim 4, which further comprises, after said removing organometals or water from the polymer solution and before said removing the activated carbon and distilling the organic solvent or said removing the activated carbon and precipitating polymers not dissolved in the polymer solution with a nonsolvent, recovering the polymer solution by centrifuging the polymer solution.

12. The method for purifying poloxamers according to claim 2, wherein the physical method comprises centrifugation of the polymer solution and the centrifugation is performed at a speed of 3,000-15,000 rpm.

13. Poloxamers purified by the method according to claim 1.

14. The poloxamers of claim 13, which have an organometal content of 10-100 ppm and a water content of 10-500 ppm.

15. Poloxamers purified by the method according to claim 2.

16. Poloxamers purified by the method according to claim 3.

17. Poloxamers purified by the method according to claim 4.

18. The poloxamers of claim 15, which have an organometal content of 10-100 ppm and a water content of 10-500 ppm.

19. The poloxamers of claim 16, which have an organometal content of 10-100 ppm and a water content of 10-500 ppm.

20. The poloxamers of claim 17, which have an organometal content of 10-100 ppm and a water content of 10-500 ppm.
